(19) United States
(12) Patent Application Publication
(10) Pub. No.: US 2026/0134256 A1
(43) Pub. Date: May 14, 2026

(54) FUEL DISPENSING ENVIRONMENT HAVING ARTIFICIAL INTELLIGENCE BASED TECHNICAL SUPPORT

(71) Applicant: Gilbarco Inc., Greensboro, NC (US)

(72) Inventors: Adam Reynolds, West Hartford, CT (US); Cristian Melone, Campi Bisenzio (IT)

(21) Appl. No.: 19/388,426

(22) Filed: Nov. 13, 2025

Related U.S. Application Data
(60) Provisional application No. 63/720,153, filed on Nov. 13, 2024.

(51) Int. Cl. G06N 3/045; G06N 3/042; G06N 3/0475

(52) U.S. Cl. CPC G06N 3/045; G06N 3/042; G06N 3/0475

(57) ABSTRACT

A remote support system for multiple geographically dispersed fueling sites comprises a remote computing resource in operative communication with the fueling sites, the remote computing resource having a machine learning supervisor and a plurality of machine learning workers, the workers each having an area of responsibility. The machine learning supervisor is operative to: (a) receive a query from a user regarding a condition at a respective one of the fueling sites; (b) process the query to identify a topic of the query; (c) based on the topic, select one or more of the workers to have responsibility for collecting information in response to the query; (d) receive the information in response to the query from the one or more workers; and (e) provide the response to the query to the user. Each of the machine learning workers is operative to: (a) when the topic falls at least in part in the worker's area of responsibility, receive a request based on the query to gather information responsive to the topic; (b) collect and curate the information responsive to the topic; and (c) provide the information responsive to the topic to the supervisor.

### CROSS-REFERENCE TO A RELATED APPLICATION

This application is based upon and claims the benefit of provisional application serial no. 63/720153, filed Nov. 13, 2024, incorporated fully herein by reference for all purposes.

### FIELD

The present invention relates generally to technical support and, more particularly, to a system and method of artificial intelligence (AI) based technical support.

### BACKGROUND

The state of the art in artificial intelligence (AI) applications within the domain of technical support has evolved significantly in recent years. As organizations increasingly rely on digital technologies, the demand for efficient and effective customer support solutions has also grown. Traditional technical support models have typically involved human agents handling customer queries, troubleshooting technical issues, and providing step-by-step solutions. While these models have been effective to an extent, they are often constrained by human limitations, such as availability, scalability, and response time.

The introduction of AI into the realm of technical support seeks to overcome these limitations. AI systems, and more specifically, machine learning (ML) models, can process vast amounts of data, identify patterns, and provide automated responses to user queries. AI-based tech support typically operates on a combination of several core technologies, including natural language processing (NLP), machine learning algorithms, and data analytics, all of which contribute to the ability to deliver highly personalized, efficient, and scalable customer service.

Natural Language Processing (NLP) plays a pivotal role in modern AI-based tech support systems by enabling machines to understand, interpret, and respond to human language in a natural and intuitive way. NLP large language models (LLM) can process user inputs, such as chat messages or voice commands, and map them to specific technical support tasks. The sophistication of NLP has improved through techniques such as deep learning, allowing these systems to better understand context, disambiguate between similar terms, and handle complex or vague queries. This has enhanced the accuracy of AI-driven interactions, allowing for more nuanced and helpful responses. LLMs are typically trained on public available data. It is possible to add more capabilities by adding a context in the queries, the source of which can came from: historical vast datasets of past interactions, technical documentation, and problem-solving scenarios, which can refine the user interactions and improve quality of the output over time. These models enable AI systems to identify the root causes of technical problems and suggest appropriate solutions by predicting the most likely outcomes based on historical data. Predictive analytics can further enhance support by proactively identifying potential technical issues before they arise, allowing AI systems to offer preemptive guidance or suggest optimizations.

AI systems in technical support are increasingly being integrated with knowledge management systems that store vast amounts of technical documentation, troubleshooting guides, and historical data. These systems enable AI to retrieve relevant information from large datasets quickly and efficiently, ensuring that users receive accurate and timely responses. Additionally, contextual understanding capabilities allow AI models to interpret the specific circumstances of a user's issue, such as device configuration, operating environment, or usage patterns, enabling more precise recommendations.

The integration of AI with Internet of Things (IoT) devices has further advanced the capabilities of tech support systems. AI-driven support can now remotely diagnose technical issues by accessing IoT device data in real-time. This enables faster identification of problems, accurate troubleshooting, and in many cases, autonomous repair or system restoration without the need for user intervention.

The state of the art in AI-powered technical support systems reflects a paradigm shift from reactive human-based models to proactive, scalable, and highly efficient AI-driven solutions. These systems leverage cutting-edge advancements in natural language processing, machine learning, and data analytics to provide real-time, personalized, and context-aware technical support.

Unfortunately, challenges remain in improving AI systems'ability to handle highly complex or unique issues.

### SUMMARY

According to one aspect, the present invention provides a remote support system for multiple geographically dispersed fueling sites. The system comprises a remote computing resource in operative communication with the fueling sites, the remote computing resource having a machine learning supervisor and a plurality of machine learning workers, the workers each having an area of responsibility. The machine learning supervisor is operative to: (a) receive a query from a user regarding a condition at a respective one of the fueling sites; (b) process the query to identify a topic of the query; (c) based on the topic, select one or more of the workers to have responsibility for collecting information in response to the query; (d) receive the information in response to the query from the one or more workers; and (e) provide the response to the query to the user. Each of the machine learning workers is operative to: (a) when the topic falls at least in part in the worker's area of responsibility, receive a request based on the query to gather information responsive to the topic; (b) collect and curate the information responsive to the topic; and (c) provide the information responsive to the topic to the supervisor.

In some exemplary embodiments, the supervisor and workers each comprise large language model artificial intelligence entities.

In some exemplary embodiments, each of the workers has access to a designated library of topical information.

In some exemplary embodiments, one or more of the workers are Retrieval-Augmented Generation (RAG) workers.

In some exemplary embodiments, the workers each perform a self-reasoning step before passing the information responsive to the topic to the supervisor. For example, the self-reasoning step may comprise at least one of checking for hallucinations, rephrasing of the question, integrating more data if the initial answer is deemed weak, using past answers, and calling a tool.

In some exemplary embodiments, the worker is capable of involving expert human intervention when deemed appropriate.

In some exemplary embodiments, each of the workers is capable of passing off at least part of an information gathering task to another one of the workers if deemed appropriate.

In some exemplary embodiments, at least one of the workers is capable of automatically generating a query for the supervisor without user interaction upon the occurrence of a predetermined trigger.

A further aspect of the present invention provides a remote support system comprising a remote computing resource having a machine learning supervisor and a plurality of machine learning workers, the supervisor and workers each comprising large language model artificial intelligence entities and the workers each have an area of responsibility. The machine learning supervisor is operative to: (a) receive a query; (b) process the query to identify a topic of the query; (c) based on the topic, select one or more of the workers to have responsibility for collecting information in response to the query; (d) receive the information in response to the query from the one or more workers; and (e) provide the response to the query. Each of the machine learning workers is operative to: (a) when the topic falls at least in part in the worker's area of responsibility, receive a request based on the query to gather information responsive to the topic; (b) collect and curate the information responsive to the topic; and (c) provide the information responsive to the topic to the supervisor.

A still further aspect of the present invention provides a method of providing remote support. The method involves a steps of providing a remote computing resource having a machine learning supervisor and a plurality of machine learning workers, the supervisor and workers each comprising large language model artificial intelligence entities and the workers each having an area of responsibility. According to another step, the machine learning supervisor is operated to: (a) receive a query; (b) process the query to identify a topic of the query; (c) based on the topic, select one or more of the workers to have responsibility for collecting information in response to the query; (d) receive the information in response to the query from the one or more workers; and (e) provide the response to the query. A still further steps involves operating at least one of the machine learning workers to: (a) when the topic falls at least in part in the worker's area of responsibility, receive a request based on the query to gather information responsive to the topic; (b) collect and curate the information responsive to the topic; and (c) provide the information responsive to the topic to the supervisor.

### BRIEF DESCRIPTION OF THE DRAWINGS

A full and enabling disclosure of the present invention, including the best mode thereof directed to one skilled in the art, is set forth in the specification, which makes reference to the appended drawings, in which:

FIG. 1 illustrates a plurality of fueling sites in operative communication with a remote support service in accordance with an embodiment of the present invention.

FIG. 2 diagrammatically illustrates certain aspects of one of the fueling sites of FIG. 1.

FIG. 3 diagrammatically illustrates certain aspects of one of the fuel dispensers located at a fueling site of FIG. 1.

FIG. 4 is a diagrammatic representation showing components of an automatic tank gauge (ATG) that may be used with one of the fueling sites of FIG. 1.

FIG. 5 shows a block diagram of an embodiment of an AI technology support system and method according to aspects of the present invention.

FIG. 6, including parts 6A-6D, shows a state diagram of an AI technology support system and method according to aspects of the present invention

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the present disclosure including the appended claims and their equivalents.

In order to provide a new and novel system and method for enhancing customer service and technology support functions and reducing the cost of such, there is provided an AI-based technology support system.

An advantage of the new and novel system is the ability to scale as demand requires.

Another advantage is the reduced cost of providing technical support.

Still another advantage is the speed at which support requests may be resolved.

A further advantage is the ability to provide answers to difficult and distinctive issues.

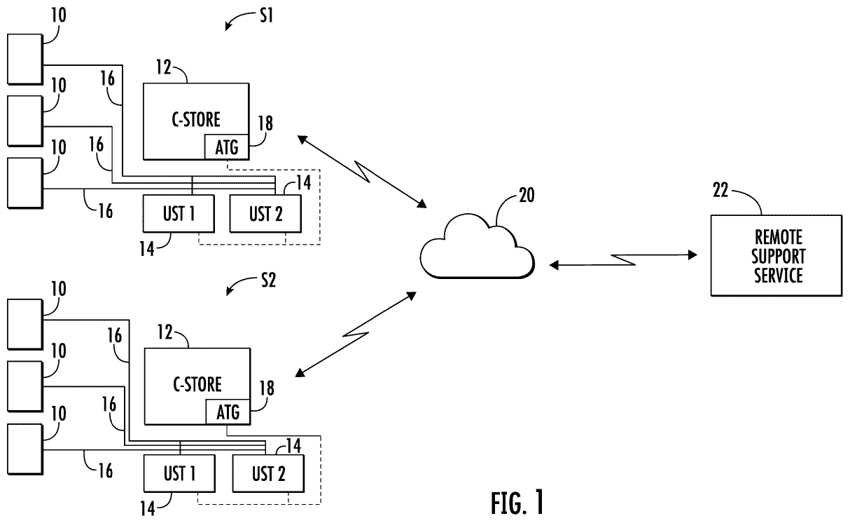

FIG. 1 shows a plurality of fueling sites S1, S2, etc. (e.g., retail service stations), each having a plurality of fuel dispensers 10. The fuel dispensers 10 are located in the forecourt area of the respective fueling site, in electrical communication with a point-of-sale (POS) system located in a building such as a respective convenience store (“C-store”) 12. Typically, the fuel dispensers 10 will be provided with “pay-at-the-pump” capability, allowing the customer to authorize and pay for the fueling transaction at the dispenser itself. The POS system authorizes payment for the fuel to be dispensed, allows dispensing to begin, and may also typically handle in-store sales activities, as well as various inventory and configuration functions.

A plurality of fuel storage tanks, here underground storage tanks (USTs) 14, are also provided, each containing a respective grade or type of fuel (higher octane, lower octane, diesel, etc.). The USTs 14 supply the selected grade or type of fuel to the dispensers 10 through appropriate piping 16 (e.g., via underground piping). Each of the fuel dispensers 10 and USTs 14 are in electrical communication with an automatic tank gauge (ATG) 18, typically located in the C-store 12. The ATGs 18, such as the TLS-450PLUS ATG sold by Veeder-Root Company, will typically utilize a combination of probe-based sensors and control consoles to monitor product levels, temperature, water presence, and tank conditions in real time.

In this case, personnel in the C-Store 12, as well as the POS and/or ATG, may communicate, such as via the cloud 20, with a remote support service 22. Service 22, an example of which is described in greater detail below, utilizes various AI technologies to generate appropriate responses to user queries, as well as to initiate automatic responses to mitigate issues developed at the respective fueling site. For example, information provided by various sensors at the fueling site (via internet of things (IoT) technology), may indicate that certain remedial action is required. When appropriate, the remedial action may be initiated by the remote support service 22 and carried our automatically at the fueling site S1, S2, etc.

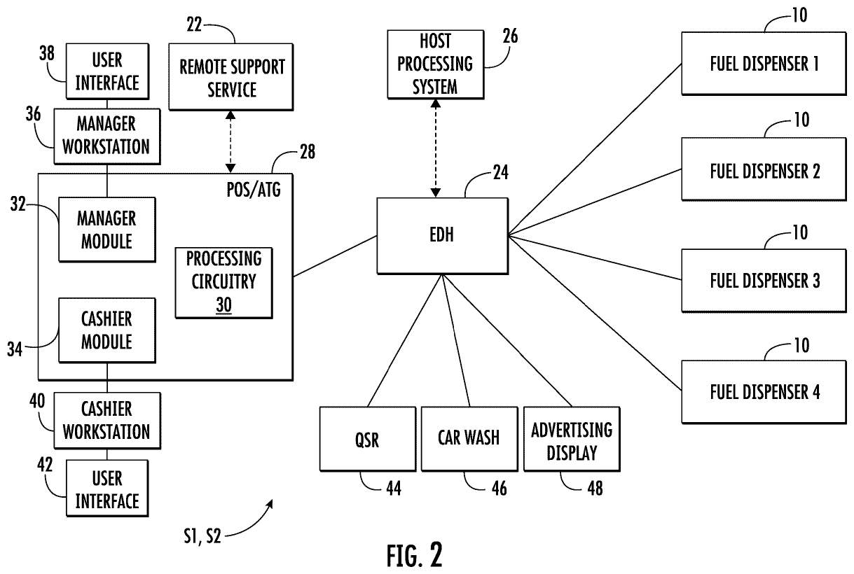

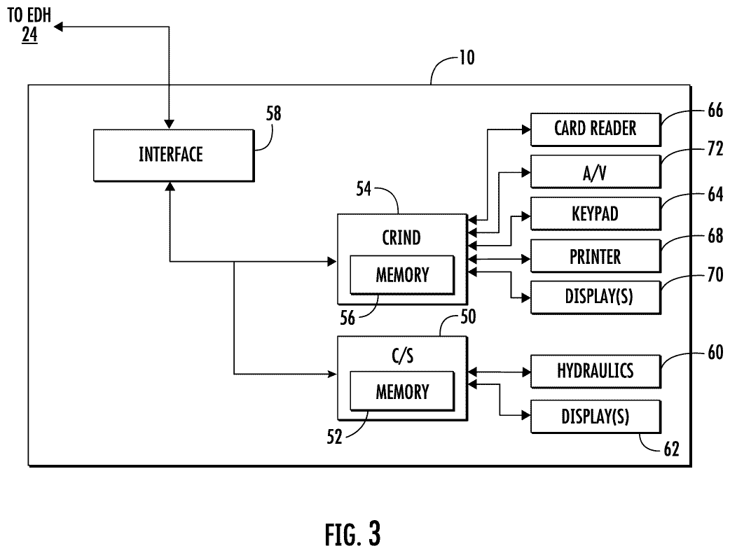

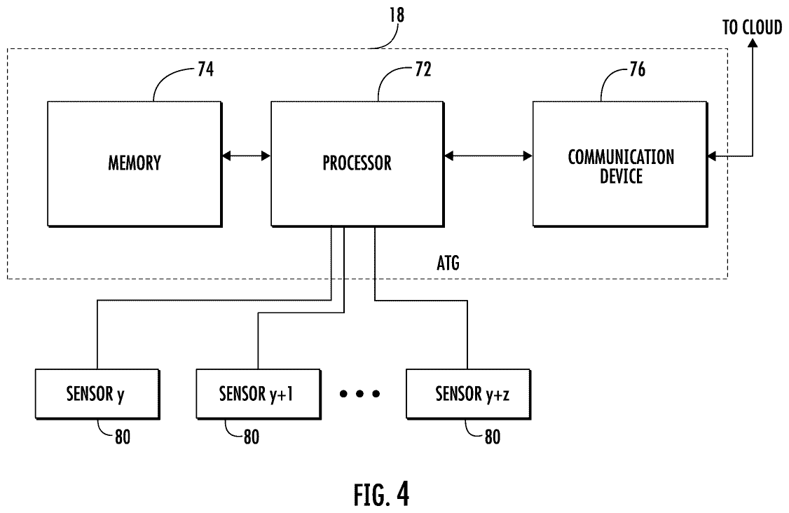

Referring now to FIG. 2, certain additional details regarding the service station S1, S2 may be described. Although embodiments are contemplated in which the electronic payment server is incorporated into or is in direct communication with POS, the illustrated embodiment utilizes an enhanced dispenser hub (EDH) 24 similar to that shown and described in U.S. Pat. No. 8,438,064 (incorporated fully herein by reference for all purposes). EDH 24 includes an electronic payment server that allows processing of payment card information. In particular, credit (or debit) card information from the fuel dispensers 10 and any in-store card readers is fed to EDH 24, which seeks approval from a remote host processing system 26 via a suitable off-site communication (e.g., the cloud).

The POS and/or the ATG (indicated collectively at 28) include appropriate processing circuitry 30. In the case of a POS, processing circuitry 30 executes several software modules including manager workstation module 32 and cashier workstation module 34. When executed, manager workstation module 32 displays a graphical user interface (GUI) on manager workstation 36 that allows the owner, operator, or manager of the service station (user) to set various fueling and other options. Manager workstation module 36 is also adapted to provide various POS capabilities, including the ability to conduct transactions for items offered for sale by the fueling station. Toward this end, manager workstation 36 includes a suitable user interface 38, such as a touchscreen display and may further include one or more speakers. As one skilled in art will appreciate, the manager workstation 36 may be incorporated into the same hardware as the POS.

Similarly, cashier workstation module 34 provides the station's cashier, clerk, or employee the means necessary to effect a transaction for one or more items or services offered by the fueling station. Cashier workstation module 34 communicates with the hardware of cashier workstation 40, which includes a user interface 42.

Additionally, the EDH 24 and/or the POS may be in communication with a quick service restaurant (QSR) 44, a car wash 46, and/or an advertising display 48. The EDH 24 and/or the POS may process orders and payments for the QSR 44 and car wash 46. The EDH 24 and/or the POS may also control the display of one or more advertising displays 48.

The fueling site may also communicate with the remote support service 22, as necessary or desired. This may be initiated by users needing assistance or automatically based on conditions occurring at the fueling site.

Referring now to FIG. 3, additional details regarding the various components of fuel dispenser 10 can be more easily explained. As shown, fuel dispenser 10 includes a control system 50 having an associated memory 52. Dispenser 10 may also comprise a CRIND (card reader in dispenser) module 54 and associated memory 56. Those skilled in the art are familiar with CRIND units used in fuel dispensers, but additional background information is provided in U.S. Pat. No. 4,967,366, the entirety of which is incorporated by reference herein for all purposes.

As shown, control system 50 and CRIND module 54 are in operative communication with EDH 24 via an interface 58. In addition, although not specifically shown in FIG. 3, either or both of control system 50 and CRIND module 54 may be in wired or wireless communication with the Internet and/or one or more cloud servers such as via the off-site communication link illustrated in FIG. 1.

Control system 50 includes the hardware and software necessary to control the hydraulic components and functions of dispenser 10. Those skilled in the art are familiar with the operation of the hydraulics 60 of dispenser 10. In general, however, fuel from the USTs 14 is pumped through piping network 16 into an inlet pipe. Fuel being dispensed passes through a flow meter, which is responsive to flow rate or volume. A displacement sensor, such as a pulser, is employed to generate a signal in response to fuel flow though the meter and communicate this information to control system 50. Control system 50 may also provide control signaling to a valve that may be opened and closed to permit or not permit dispensing of fuel.

Meter flow measurements from the displacement sensor are collected by control system 50. Control system 50 also typically performs calculations such as cost associated with a fuel dispensing transaction. As a dispensing transaction progresses, fuel is then delivered to a hose and through a nozzle into the customer's vehicle. Dispenser 10 typically includes a nozzle boot, which may be used to hold and retain the nozzle when not in use. The nozzle boot may include a mechanical or electronic switch in communication with control system 50 to indicate when the nozzle has been removed for a fuel dispensing request and when the nozzle has been replaced, signifying the end of a fueling transaction. Control system 50 may thus determine whether a transaction has been initiated or completed.

Control system 50 may further be operative to control one or more displays 62. For example, a transaction price total display may present customers with the price for fuel that is dispensed. A transaction volume total display may be used to present customers with the measurement of fuel dispensed in units of gallons or liters. Finally, price per unit (PPU) displays may be provided to show the price per unit of fuel dispensed in either gallons or liters, depending on the programming of dispenser 10.

CRIND module 54 includes the hardware and software necessary to support payment processing and peripheral interfaces at dispenser 10. In this regard, CRIND module 54 may be in operative communication with several input devices. For example, a PIN pad 64 is typically used for entry of a PIN if the customer is using a debit card for payment of fuel or other goods or services. CRIND module 54 may also be in operative communication with a card reader 66 for accepting credit, debit, or other magnetic stripe or chip cards for payment. Additionally, card reader 66 may accept loyalty or program-specific cards as is well known. Further, CRIND module 54 may be in operative communication with other payment or transactional devices such as a receipt printer 68.

One or more display(s) 70 may be used to display information, such as transaction-related prompts and advertising, to the customer. The customer may use soft keys to respond to information requests presented to the user via a display 70. In some embodiments, however, a touch screen may be used for display 70.

Audio/video electronics 72 are adapted to interface with the CRIND module 54 and/or an auxiliary audio/video source to provide advertising, merchandising, and multimedia presentations to a customer in addition to basic transaction functions. The graphical user interface provided by the dispenser may allow customers to purchase goods and services other than fuel at the dispenser. For example, the customer may purchase a car wash and/or order food from the store while fueling a vehicle.

In operation, a user positions a vehicle adjacent to one of dispensers 10 and uses the dispenser to refuel the vehicle. For payment, the user typically inserts and removes a payment card from a card information reader at the dispenser. The card information reader reads the information on the payment card and transmits the information to EDH 24. EDH 24 provides the payment information to the appropriate host processing system 26 operated by the financial institution associated with the user's payment card. The financial institution either validates or denies the transaction and transmits such a response to EDH 24. This may include transmitting to dispenser 10 a request that the user provide another payment card if the transaction is denied.

Certain aspects of the ATG 18 may be explained with reference to FIG. 4. As shown, the ATG 18 may include a processor 72, a memory 74, and a communication device 76. Processor 72 (and any of the other processors discussed herein) may be any suitable electronics whether referred to as a processor, microprocessor, controller, microcontroller, or other suitable electronics with associated memory and software programs running thereon. (As used in this document, the foregoing terms, e.g., processor, etc., are all intended to be synonymous.) Memory 74 may be any suitable memory or computer-readable medium as long as it is capable of being accessed by processor 72, including one or more of random access memory (RAM), read-only memory (ROM), erasable programmable ROM (EPROM), or electrically EPROM (EEPROM), CD-ROM, DVD, or other optical disk storage, solid-state drive (SSD), magnetic disc storage, including floppy or hard drives, any type of suitable non-volatile memories, such as secure digital (SD), flash memory, memory stick, or any other medium that may be used to carry or store computer program code in the form of computer-executable programs, instructions, or data. Processor 72 and memory 74 may be distributed over multiple physical chips as necessary or desired.

Device 76 provides communication with remote support service 22. In this regard, communication device 76 may be any suitable device or circuitry embodied in hardware, software, or a combination of hardware and software that is configured to receive and/or transmit data from/to a network and/or any other device or module in communication with the ATG 18, such as via ethernet, DSL, cellular communication, etc. Such communication may be encrypted and may occur through the site controller or directly from the fuel dispenser via wired or wireless protocols.

As can be seen, processor 72 is preferably in communication with multiple sensors 80, such as various liquid level sensors, pressure sensors, temperature sensors, humidity sensors, line leak detection systems and sensors, etc., as necessary or desired. Such sensors are available from Veeder-Root Company.

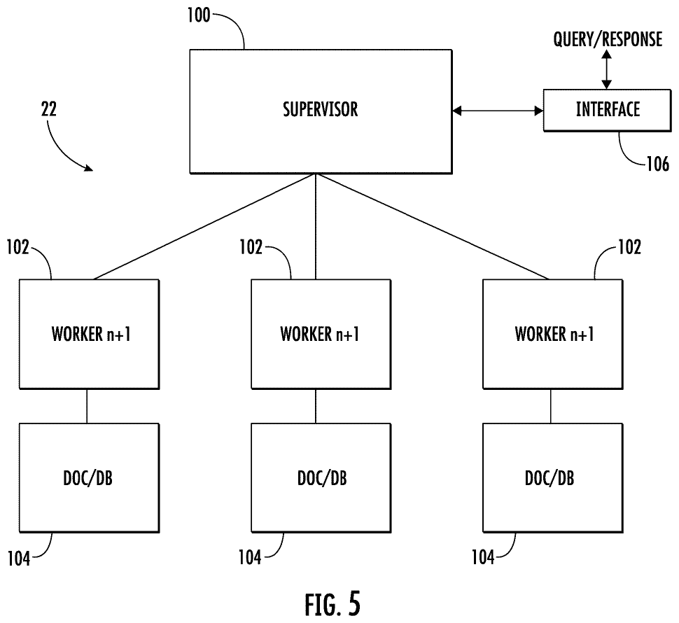

Turning now to FIG. 5, an example of the novel AI-based technical support system (generally 22) described herein is illustrated. The system includes a supervisor 100, one or more “workers” 102, and one or more knowledge sources 104 accessible by the workers. An interface 106 for communicating and interacting with the system is also provided. Such an interface may be via voice, keyboard or other appropriate data entry device.

Each worker 102 may be embodied as an LLM AI orchestrated by the supervisor 100 also embodied as a LLM AI. The workers 102 may respectively act as a help desk agent for Customers, ASCs, Field Engineers, etc. Each of the workers 102 may preferably have its own system message describing the list of tasks in a “job description” like form, the type of interaction allowed, the style of the answers to be used and some contextual additional current data (such as current date/time, users information/capabilities, etc.). In addition, it may be equipped with the means to implement a Retrieval-Augmented Generation (RAG) system, which is an advanced artificial intelligence architecture that integrates two key components: retrieval and generation. RAG combines traditional information retrieval techniques with generative models, such as large language models, to produce more accurate, contextually relevant, and up-to-date responses. In this exemplary embodiment, each of the specific RAG systems is limited to returning answers based on a set of documents such as technical publications or a database/system (e.g., JIRA, ERP, CRM, etc.) to which they have access.

In operation, the supervisor 100 receives input from the user requiring support and then relays the information to the RAG workers 102. The retrieval component of the system fetches relevant information from a large external knowledge base, such as a respective database or document set 104, typically using a vector/graph database. Advantageously, each of these knowledge bases include highly specialized and specific information so that the system can quickly and efficiently handle highly complex problems.

After retrieving relevant documents or information, the generative model processes this data and generates a coherent and contextually appropriate output. This generative step ensures that the final output is not merely a copy of the retrieved documents but is synthesized, interpreted, and articulated in a way that aligns with the user's request. Finally, the information is passed to the supervisor 100 to be provided to the user.

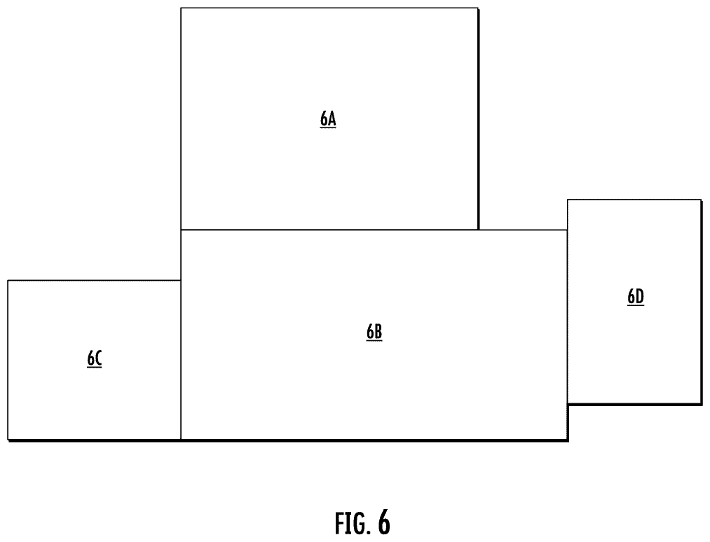

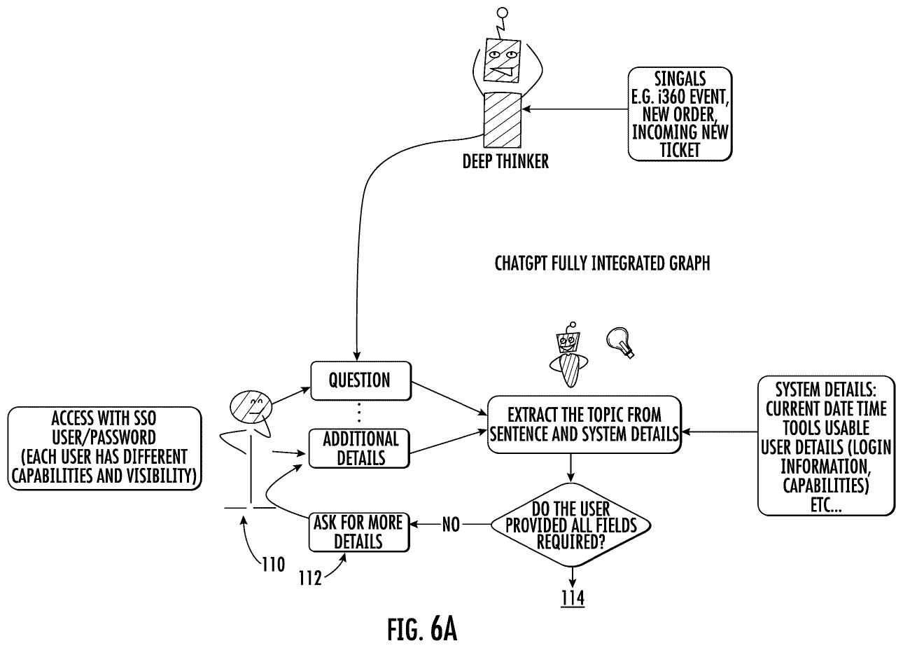

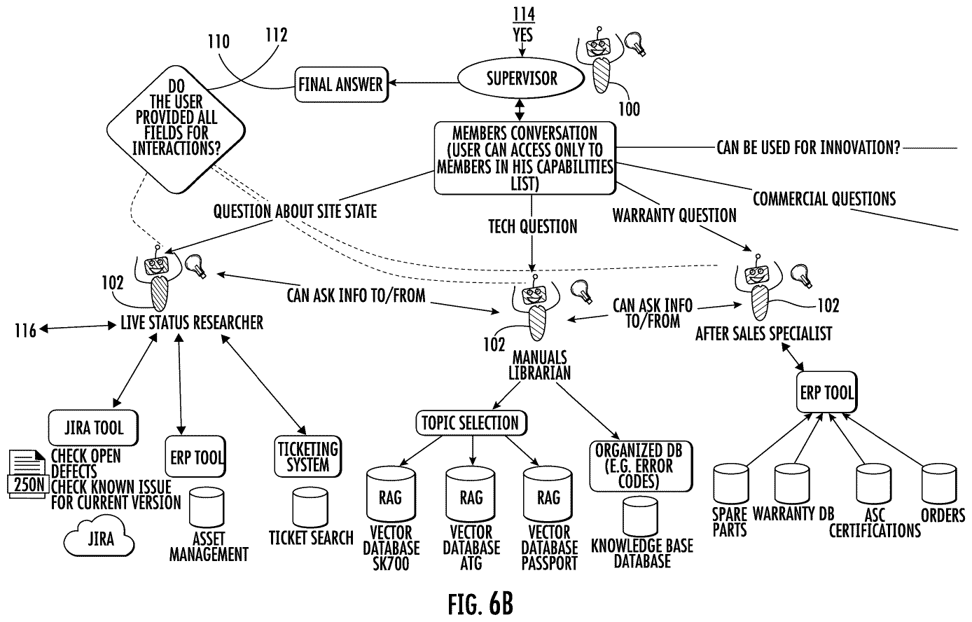

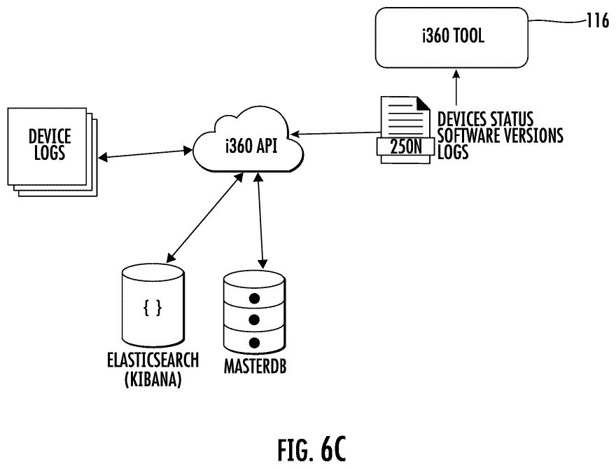

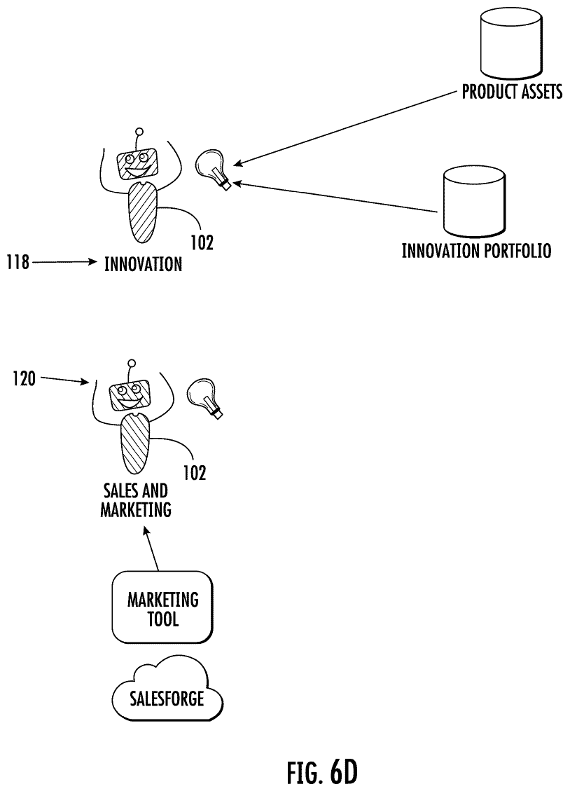

Turning now to FIG. 6, it should be noted that the above is not always a single step operation. The worker can define some sub-state conditional or unconditional. For example, before returning to the supervisor, it might apply some self-reasoning steps including:
Checking for hallucinations in the answer.
Rephrasing the questions to achieve more precise results and processing again.
Integrating more data into the context if the initial answer is “weak” relative to the one passed by the user.
using past answers.
Calling a tool and checking results. This is done by defining a list of available tools and data formatting to call them. The LLM in that case provides parameters to be used so the application running the LLM worker can run it. Once the run is finished, it passes the tool output as context to complete the subtask. This broadens the capabilities, for example, to send an email, run any command on bash, query data from databases, compile an application, call a REST service, read information from the Internet, check past tickets for a specific device/site/issue contextually (e.g., if the last time a site had an issue that was fixed with a workaround, but the same issue happens again, that first solution may be integrated into the system as context to make workers capable of finding a more effective solution for that specific site knowing what was done in the past), etc.
Depending on the task it can also implement a human-in-the-middle approach, where the sub-task is interrupted to escalate the answer to a real person, context is saved and when the real person intervention is completed, continues its job of keeping the old context and using new information (even after days).
In addition to being called by a user writing a question in a prompt window, it can also be triggered when a certain event happens, for instance a new sale is completed, a new software or hardware version is released, a bug fixed/discovered, customer tickets inserted, a time-based action, etc.
Discovering that the question is not for that particular worker and suggests to the supervisor to ask some other workers, including naming them if the supervisor forwards the “job description” of the other workers
   The supervisor collects the responses and combines them to provide a complete answer to the user. Note that the data sources are optional and could be scaled up and down over time and depending on the user. Each data source is paired with a worker, thereby enabling the number of workers to be scalable as well.

By way of example only and not limitation, several worker configurations are described as a unique combination of existing AI techniques, including:
CONTACT CENTER SUPERVISOR: Can process input prompts and identify the worker to ask to complete the answer. Multiple workers may be identified based on outputs.
HELP DESK WORKER: Based on input, the worker can define a different path and use sub-workers that:
   Can access a knowledge base vector/graph database distilled from PDF manuals, troubleshooting guides, list known issues etc. (e.g., prompt, “what do I need to do in case of error 101?”).
   Can access (via a tool) a ticketing system and read current and past tickets that can be used as context (e.g., prompt, “what's wrong with site 1234?”). This turns into a query to be used with the ticketing system, wherein the answer is not sent back directly to the supervisor. However, since it has access to the knowledge base mentioned above, it may search for a resolution.
   Can access the device's current state via cloud, if the device is connected to it (e.g., prompt, “what is the state of device Id 3442?” and generate an internal sub-task call, “I've seen the site 1234 has a ticket with issue on device Id3442, can you check the state to assess if is still malfunctioning?”).
   Can access project management software (e.g., Jira) to check if the current version of the context has some known bug (e.g., prompt, “I see the site 1234 has a ticket with an issue and saw from the cloud that the system has version A4.455. Can you check if this issue matches with the known one?”). In case of known bugs, while answering the question a trigger procedure may be created that will be activated when the bug is fixed. So, for instance, the specific site that had the issue can be contacted and it can be suggested to upgrade the version. Or, if available, an automatic update can be scheduled via tool access.
   Can use a human in the middle process wherein the worker knows the list of real person experts and can decide to escalate to them (e.g., via email, Teams, etc.). The question is used to get confirmation or a new answer. This also will be stored as past retrievable data in case the same question is asked. Thus, it is possible to answer the prompt directly without engaging the expert again.
   Can decide if the question is not for it and suggest another worker.
   Can also cooperate with other workers. For example, in the case of an action related to a warranty intervention that might be expired, it can contact the sales and marketing/warranty manager worker and check if there is any promotion in warranty that they want to suggest that the customer buy.
SALES AND MARKETING WORKER:
   Can access current orders (e.g., sales force).
   Can check via tool, order shipment.
   Can access knowledge base vector/graph database distilled from pdf manuals, best practices guides, company standards etc. (e.g., prompt, “What is the procedure to seal a dispenser?”).
   Can use a human in the middle: workers know the list of real person experts and can decide to escalate to them (e.g., via email, Teams, etc.) any questions that need to have confirmation or get new answers. This fosters new opportunities and create customer interaction.
   Can open a ticket for help desk in case the question turns out to be an issue (e.g., “I received new equipment that works, but with less functionalities than expected.”).
   Can cooperate with others, like a help desk worker.
WARRANTY WORKER:
   Like the help desk example provided above, but specific to warranty management. For example, the human-in-the middle is used more often since warranty management involves shipments, repairing department contacts, engineer on field checks, etc.
INNOVATION WORKER:
   This is a special worker capable of checking if there is any opportunity for innovation coming from other workers' queries. It collects all the possible areas of development, as the knowledge base includes a portfolio of ideas, Point of Contact (PoC), MVP, project, current product description etc.
   In an ISO 56002 IMS this represents an internal and external issues observer for innovation opportunities and can be used also for other purposes of the standard.
   Also, the innovation worker can work as “match maker” in case an unreleased innovation can solve a real issue, rebalancing the idea weight (e.g., there is an idea/technology marked as low impact for business, based on a match with the issue can be increased to high impact, because it can be applied to a field that was not foreseen earlier).
DEEP THINKER WORKER:
A special worker that can auto-generate queries for the supervisor without user interaction.
Exemplary triggers may include:
   New ticket entry
   New Jira issue entry
   New order
   Time based
   Custom trigger user defined
   Other tools notification customizable
   As result of a previous worker's interactions
   Periodic status check as the base of predictive maintenance (also including generating a Teams meeting to discuss a summary of information, innovation ideas, sales results, etc.)
An example of deep thinker action based on a new ticket includes:
   Trigger: A new ticket has been inserted by the customer
   Deep thinker asks help desk worker to analyze the issue
   The answer is attached to the ticket, so when humans read it they will find:
      Ticket text: [Original Ticket]
      AI Analysis: [Analysis with possible details of how to fix the issue]
   In case it is possible to apply some automatic fix safely, the ticket can also be directly closed with the resolution containing the list of actions taken.
      It is to be noted that other embodiments are possible. The provided examples are not meant to limit the spirit and scope of the new and novel innovation disclosed herein.

Many modifications and other embodiments of devices and/or methodology set forth herein will come to mind to one skilled in the art to which they pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A remote support system for multiple geographically dispersed fueling sites, the system comprising:
a remote computing resource in operative communication with the fueling sites, the remote computing resource having a machine learning supervisor and a plurality of machine learning workers, the workers each having an area of responsibility;
the machine learning supervisor being operative to:
receive a query from a user regarding a condition at a respective one of the fueling sites;
process the query to identify a topic of the query;
based on the topic, select one or more of the workers to have responsibility for collecting information in response to the query;
receive the information in response to the query from the one or more workers; and
provide the response to the query to the user; and
each of the machine learning workers being operative to:
when the topic falls at least in part in the worker's area of responsibility, receive a request based on the query to gather information responsive to the topic;
collect and curate the information responsive to the topic; and
provide the information responsive to the topic to the supervisor.

2. A remote support system as set forth in claim 1, wherein the supervisor and workers each comprise large language model artificial intelligence entities.

3. A remote support system as set forth in claim 2, wherein each of the workers has access to a designated library of topical information.

4. A remote support system as set forth in claim 1, wherein one or more of the workers are Retrieval-Augmented Generation (RAG) workers.

5. A remote support system as set forth in claim 1, wherein the workers each perform a self-reasoning step before passing the information responsive to the topic to the supervisor.

6. A remote support system as set forth in claim 5, wherein the self-reasoning step comprises at least one of checking for hallucinations, rephrasing of the question, integrating more data if the initial answer is deemed weak, using past answers, and calling a tool.

7. A remote support system as set forth in claim 1, wherein the worker is capable of involving expert human intervention when deemed appropriate.

8. A remote support system as set forth in claim 1, wherein each of the workers is capable of passing off at least part of an information gathering task to another one of the workers if deemed appropriate.

9. A remote support system as set forth in claim 1, wherein at least one of the workers is capable of automatically generating a query for the supervisor without user interaction upon the occurrence of a predetermined trigger.

10. A remote support system comprising:
a remote computing resource having a machine learning supervisor and a plurality of machine learning workers, the supervisor and workers each comprising large language model artificial intelligence entities and the workers each have an area of responsibility;
the machine learning supervisor being operative to:
receive a query;
process the query to identify a topic of the query;
based on the topic, select one or more of the workers to have responsibility for collecting information in response to the query;
receive the information in response to the query from the one or more workers; and
provide the response to the query; and
each of the machine learning workers being operative to:
when the topic falls at least in part in the worker's area of responsibility, receive a request based on the query to gather information responsive to the topic;
collect and curate the information responsive to the topic; and
provide the information responsive to the topic to the supervisor.

11. A remote support system as set forth in claim 10, wherein each of the workers has access to a designated library of topical information.

12. A remote support system as set forth in claim 10, wherein one or more of the workers are Retrieval-Augmented Generation (RAG) workers.

13. A remote support system as set forth in claim 10, wherein the workers each perform a self-reasoning step before passing the information responsive to the topic to the supervisor.

14. A remote support system as set forth in claim 13, wherein the self-reasoning step comprises at least one of checking for hallucinations, rephrasing of the question, integrating more data if the initial answer is deemed weak, using past answers, and calling a tool.

15. A remote support system as set forth in claim 10, wherein the worker is capable of involving expert human intervention when deemed appropriate.

16. A remote support system as set forth in claim 10, wherein each of the workers is capable of passing off at least part of an information gathering task to another one of the workers if deemed appropriate.

17. A remote support system as set forth in claim 10, wherein at least one of the workers is capable of automatically generating a query for the supervisor without user interaction upon the occurrence of a predetermined trigger.

18. A method of providing remote support, the method comprising steps of:
providing a remote computing resource having a machine learning supervisor and a plurality of machine learning workers, the supervisor and workers each comprising large language model artificial intelligence entities and the workers each having an area of responsibility;
operating the machine learning supervisor to:
receive a query;
process the query to identify a topic of the query;
based on the topic, select one or more of the workers to have responsibility for collecting information in response to the query;
receive the information in response to the query from the one or more workers; and
provide the response to the query; and
operating at least one of the machine learning workers to:
when the topic falls at least in part in the worker's area of responsibility, receive a request based on the query to gather information responsive to the topic;
collect and curate the information responsive to the topic; and
provide the information responsive to the topic to the supervisor.

19. A method as set forth in claim 18, wherein the at least one worker performs a self-reasoning step before passing the information responsive to the topic to the supervisor.

20. A method as set forth in claim 19, wherein the self-reasoning step comprises at least one of checking for hallucinations, rephrasing of the question, integrating more data if the initial answer is deemed weak, using past answers, and calling a tool.
